(19) United States
(12) Patent Application Publication
(10) Pub. No.: US 2015/0339639 A1
(43) Pub. Date: Nov. 26, 2015

(54) System and Methods For Inducing Donation Decision-Making Based On Context-Awareness

(71) Applicant: Myongsu Choe, Montreal (CA)

(72) Inventor: Myongsu Choe, Montreal (CA)

(21) Appl. No.: 14/717,585

(22) Filed: May 20, 2015

Related U.S. Application Data
(60) Provisional application No. 62/001,340, filed on May 21, 2014.

(51) Int. Cl. G06Q 20/10; G06Q 30/02

(52) U.S. Cl. CPC G06Q 20/10; G06Q 30/0279

(57) ABSTRACT

This invention is about a system and the methods for collecting donations by using context-awareness based on a social networking service.

### CROSS-REFERENCE TO RELATED APPLICATIONS

This application claims the benefit of U.S. Provisional Application No. 62/001,340, filed on 21 May 2014. The entire disclosure of the above application is incorporated herein by reference.

### FIELD

This invention comprises of a system and methods for raising donations and funds based on sales-assisting devices when an act of purchase has occurred, and more specifically, it is related to raising donations and funds using a context-awareness technology based on a social networking service.

### BACKGROUND

Due to economic progress and the development of science and technology, in comparison with past times, the economic scale has been remarkably growing and our society has become more enriched. However, due to the intensifying polarization of incomes, the majority of people do not have any benefits from its economic progress. Therefore, communities, corporations, and individuals as well as charity organizations have been increasing their concerns on donation offerings and social voluntary services to aid the people who are desperately in need of help and care from adjacent neighbors.

Accordingly, based on the recent increase of concerns, the amount of donations by donors (individuals, organizations, communities, and more) and donation frequency are in the growing trends. Various donation methods to the charity organizations have been carried out by telephone calls known as an ARS (Audio Response System or Automatic Response Service), or by a letter enclosed with a check, or through an online payment via the Internet, or a money transfer by a bank institution, or through cash payment by directly visiting the charity organization, and others more.

### SUMMARY

When a donor contributes donations to a charity organization generally, the donor and the charity organization have a direct donation relationship where there is no intermediate means between them such as 1:1, 1:N, N:1, N:M, where N is not equal to M.

Generally, when a donor's personal preference matches with the founding purposes and activities of a charity organization, then the donor has a probable chance to donate to the corresponding charity organization. Therefore, most of the traditional donation methods are attempting to search a perfect match between the donor's preferences and the charity organization's ethos and establishment purposes. If they do not match, then the traditional donation methods may not be able to induce donations.

In a situation where a donation is more likely to occur, requesting donations at that moment may trigger probable chances in raising donations and funds. When people choose to purchase products or services, just before paying for them, requesting a donation may be the most accurate moment to collect more donations successfully because they are momentarily ready to pay. Therefore, when people attempt to purchase products or services, requesting to make a donation just before the payment may be an appropriate moment to collect donations.

A smartphone or a personal computer connected by a network like a traditional sales-assisting device such as a POS (Point Of Sale) terminal, an ATM (Automatic Teller Machine), a ticket machine, a vending machine, and other similar devices can be used for collecting donations and funds.

Amongst these donating activities, even if many donors have positive and affirmative attitudes towards making donations, they usually lack the understanding when it comes to the infrastructure and the information on the donation such as having an insufficient and limited access to the charity organization, a lack of information on making donations, and even misunderstanding about the donation methods, which makes the act of donation exceedingly restrictive as a result.

Furthermore, the lack of sharing information and mutual monitoring raised by the donor's donating activities can cause non-transparent usage by the charity organization's received donations. Also, due to the fact that misconducting charity organizations spend their received donations for illegal purposes, a negative influence on the donating culture can be formed, thereby blocking the proliferation of a favorable donation culture.

To avoid embezzlement and misuse of the collected donations and funds by charity organizations, it is important and necessary to release the donation results and share its usage purposes to the public by an SNS (Social Networking Service), in order to efficiently manage a transparent donation.

Therefore, this invention's main goal is to provide a system and methods for collecting donations and funds based on social connectivity, wherein using a context-awareness concept to promote donation and funds through a sales-assisting device such as a POS terminal, an ATM, a ticket machine, a vending machine, and a smartphone or a personal computer connected to a network, it enables a buyer to determine donation related decisions by providing the buyer with an advertisement or campaign messages provided by a charity organization, apart from purchasing products or services at a point of purchase. Furthermore, it helps to resolve some issues such as the donation information that is not associated to the donor's social connections, or inactive donation activities caused by the mishandling of donation money, or the guarantee of making transparent donations by the charity organization, as well as a necessity of real-time based concurrent donation, and others.

### Technical Solution

In accordance with an example of an embodiment of the present invention, a system for collecting donations when purchasing products or services by using an online payment system comprises of a product/service purchase and donation processing unit, wherein it transfers an amount of donation, which is to be entered by determining on the ‘donee related information containing a message for donation inducement’ received from a social donation server to an account of a charity organization; and the social donation server, wherein it manages and operates the transferred donations, and it computes a level of donation corresponding to a donation preference level or a donation amount level or both levels by predicting a future act of donation in reflection of a past donation history (donation preference and donation amount levels) and a current act of donation (donation results and donation amount), and it provides as a result, a ‘donee related information containing a message for donation inducement’ which is closely matched with the level of donation to the donor by the product/service purchase and donation processing unit, the next time the donor purchases products or services.

In accordance with an example of an embodiment of the present invention, a system for collecting donations when purchasing products or services using an offline payment system comprises of a product/service purchase and donation processing unit, wherein it transfers an amount of donation, which is to be entered by determining on the ‘donee related information containing a message for donation inducement’ received from a donation management unit to an account of a charity organization; and the donation management unit, wherein it manages and operates the provided donations, and it computes a level of donation that corresponds to a donation preference level or a donation amount level or even both levels by predicting a future act of donation in reflection of a past donation history (donation preference and donation amount levels) and the current act of donation (donation results and donation amount), and it provides as a result, ‘donee related information containing a message for donation inducement’ which is closely matched with the level of donation to the donor by the product/service purchase and donation unit, the next time the donor purchases products or services.

In accordance with an example of an embodiment of the present invention, a method for collecting donations when purchasing products or services by using an online payment system comprises of a transferring phase, wherein it transfers an amount of donation, which is to be entered by determining on the ‘donee related information containing a message for donation inducement’ that is received to an account of a charity organization, when a donor purchases products or services; and a computing donation level phase, wherein it computes a level of donation that corresponds to a donation preference level or a donation amount level or even both levels by predicting a future donation action in reflection of a past donation history (donation preference and donation amount levels) and a current act of donation (donation results and donation amount); and a providing phase, wherein it provides as a result, a ‘donee related information containing a message for donation inducement’ which is closely matched with the level of donation to the donor, the next time the donor purchases products or services.

In accordance with an example of an embodiment of the present invention, a method for collecting donations when purchasing products or services by using an offline payment system comprises of a transferring phase, wherein it transfers an amount of donation, which is to be entered by determining on the ‘donee related information containing a message for donation inducement’ that is received to an account of a charity organization, when a donor purchases products or services; a computing donation level phase, wherein it computes a level of donation corresponding to a donation preference level or a donation amount level or even both levels by predicting a future donation action in reflection of a past donation history (donation preference and donation amount levels) and a current act of donation (donation results and donation amount); and a providing phase, wherein it provides as a result, ‘donee related information containing a message for donation inducement’ which is closely matched with the level of donation to the donor, the next time the donor purchases products or services.

### Advantageous Effects

With the traditional donation method which attempts to search perfect matching between a donor's preference and a charity organization's activities, when a donor's preference is not matching with a charity organization's activities, then the donation cannot be preceded. However, with this invention, by simply providing randomly selected donation inducing information to a buyer who has not yet made a payment for the purchased products or services, it may elevate the chances of making a donation.

According to this invention, apart from the traditional sales-assisting devices such as a POS terminal, an ATM machine, a vending machine, and a ticket machine, a donor's smartphone or personal computer can also be used to receive the previously stored ‘donee related information containing a message for donation inducement’ that matches with the computed level of donation in order to induce the donation.

According to this invention, when purchasing products or services, prior to making a payment, a buyer will receive an announcement or advertisement messages that match with the buyer's preferences, thereby helping the buyer to make more donations.

According to this invention, beyond the current limited donation methods with 1:1, 1:N, N:1, N:M connections, this system and methods for collecting donations based on social networking services by using social connections can create many advantageous effects.

According to this invention, as public benefit aspects, when natural disasters or certain unpredictable events have occurred, it has an effect to secure prompt donation collections and to transfer it to the people or the organizations that are in need. Moreover, due to the accumulation of real-time donations, by utilizing social networking services as a basis, it is possible to immediately confirm an enforcement of the supervision as well as the monitoring of the accumulated donation sources and the usage of donations by the charity organization. Based on these means, through evaluations and recommendations in regards to charity organizations, donors, and donation deliverers, it can possibly impact in becoming a virtuous circle for solely sustaining the good charity organizations and sellers in a market.

According to this invention, we will also post a special mark (or a sticker) printed with “Beautiful Donation (as an example of an embodiment)” at the store where the sales-assisting device is installed, and by advertising information capable of making donations all the time at the store, it can also help to make the store more distinguished, and contribute in making more profits by posting advertisements on the sales-assisting device.

According to this invention, via a social donation network based on a social networking service, through the formation of human networks consisting of charity organizations, donors, and others, it enables to share targets and achievements of the donations in terms of the donation amounts and businesses on a real-time basis. By providing and sharing real-time information related to adjacent stores and locations of members in a human network, it can contribute to the increase of overall communications within communities regarding the donations by giving more chances to meet in online and offline spaces.

Moreover, according to this invention, by computing donation preference and donation amount levels in order to provide customized context-awareness services for sales-assisting devices and donors, it enables to recommend an achievement of a maximum of donations, thereby having effects to maximally collect donations.

### BRIEF DESCRIPTION OF THE DRAWINGS

FIG. 1 is a traditional donation method, illustrating an instance where a donor is directly linked to a charity organization. And the donation can be given in the form of money, products, services, and talents between the donors and the charity organizations.

FIG. 2 is a schematic diagram of a social network linked by social connections between donors and charity organizations.

FIG. 3 is a social donation network based on social connections, by adding additional devices such as advertisement display devices and sales-assisting devices like an ATM, a POS terminal, a vending machine, and a ticket machine to a social network consisting of donors and charity organizations, in accordance with an example of an embodiment of a donation method.

FIG. 4 illustrates a donation method, exchanging donations from a donor to a charity organization via a donation transfer agent when a donor purchases products or services, as a donation method in accordance with an example of an embodiment.

FIG. 5 depicts a donation method based on a social donation network, which is socially connected with donors, charity organizations, and donation transfer agents. The donation transfer agent is embodied by advertisement display devices, sales-assisting devices, PCs (Personal Computers) and smartphones used by donors and charity organizations in accordance with an example of an embodiment.

FIG. 6 illustrates a system for collecting donations, consisting of a product/service purchase and donation processing unit, and a social donation server according to an example of an embodiment.

FIG. 7 illustrates an example of donation by showing a list of charity organizations to a donor according to an example of an embodiment.

FIG. 8 illustrates an example of donation by displaying a message to the donor and requesting donations when a donor chooses a charity organization according to an example of an embodiment.

FIG. 9 depicts an example of donation by displaying an event message which requests donations for a donor according to an example of an embodiment.

FIG. 10 is a schematic diagram of a donation level computing subunit in a system for collecting donations according to an example of an embodiment.

FIG. 11 illustrates a flowchart of a donor's donation method according to an example of an embodiment.

FIG. 12 illustrates a flowchart of a donor's donation method according to another example of an embodiment.

FIG. 13 shows an example of a donation receipt when a donor purchases products or services according to an example of an embodiment.

FIG. 14 shows an example of donee related information (message) given to a donor, in accordance with an example of an embodiment.

FIG. 15 shows an example of donee related information (message) given to a donor in the form of a unilateral message list, according to an example of an embodiment.

FIG. 16 shows another example of donee related information (message) given to a donor in the form of a bilateral message list, according to an example of an embodiment.

FIG. 17 illustrates a timing diagram showing donation flows between a product/service purchase and donation processing unit and a social donation server (in case of an offline payment, a donation management unit) when a donor purchases products or services in accordance with an example of embodiment.

### DETAILED DESCRIPTION

The previously described goals, features, and benefits will be more evident by the detailed explanations accompanied with references of the enclosed diagrams. Moreover, those who have common knowledge in the technology that the present invention encompasses can implement the technological concepts of this invention with ease. Furthermore, in the course of the explanation regarding this invention, when it is determined that the detailed explanations about the common technology relevant to this invention may unnecessarily raise ambiguity about the gist of the invention, then a detailed description on that part will be omitted. In other words, detailed descriptions which might raise ambiguity when it comes to this invention, such as data processing-related functions and configurations, namely announcement feature, membership subscription, login, connection, search, query, registration, modification, deletion, and more will be omitted.

In addition, all of the detailed explanations enumerated with specific embodiment examples as well as the principles, aspects, and embodiment examples of the present invention should be understood to be able to include what was intended as having structural and functional equivalents to these items. Also, all of these equivalents are not only currently announced ones but they are also equivalents that will be developed in the future. In addition, they should also be understood by including all the components that are to be invented, in order to perform the same functionality, irrespective of the structures. Thus, for example, the block diagrams in this invention's description should be understood by representing conceptual viewpoints of illustrative circuits embodying the principles of the present invention. Similarly, all of the flowcharts, state transition diagrams, pseudo code, and the like can substantially be represented as readable media by a computer, and should be understood to be represented as various processes that are run by a computer or a processor regardless of whether a computer or a processor is explicitly illustrated or not. A processor or the functions of various components depicted in a schematic diagram with functional blocks, represented in similar concepts can be provided not only by dedicated hardware but also by hardware with the capacity to be executed by the appropriate software. When it is provided by a processor, the above-mentioned functions may be given by a single dedicated processor, a single shared processor, or by a plurality of individual processors, in which some of these processors may be shared.

Also, a processor, control or the clear use of terms presented as similar concepts cannot be construed by exclusively quoting the hardware with the capacity of a software execution, and without any limitations, DSP (Digital Signal Processor) hardware, ROM (Read Only Memory) for storing software, RAM (Random Access Memory) and non-volatile memory should be understood, in order to be implicitly included. Using other hardware with common knowledge and common use can also be included. In the scopes of the claim, in regards to this description, components that are represented as the means to perform the functions that are described in the detailed explanations are intended to include all of the methods by performing any type of software in combination with circuit elements or firmware/microcode and the like. And in order to perform the aforementioned functions, it combines appropriate circuitry that is capable of executing the aforementioned software. Due to the fact that this invention is defined by these claimed scopes, it can be combined with the functions that are provided by various enumerated means and also be combined with the methods that the claims demand. In addition, any means to provide the aforementioned functions can equivalently be understood as what is perceived from this description.

Hereinafter, in reference to the attached drawings, a preferred example of an embodiment according to the invention is to be described in detail.

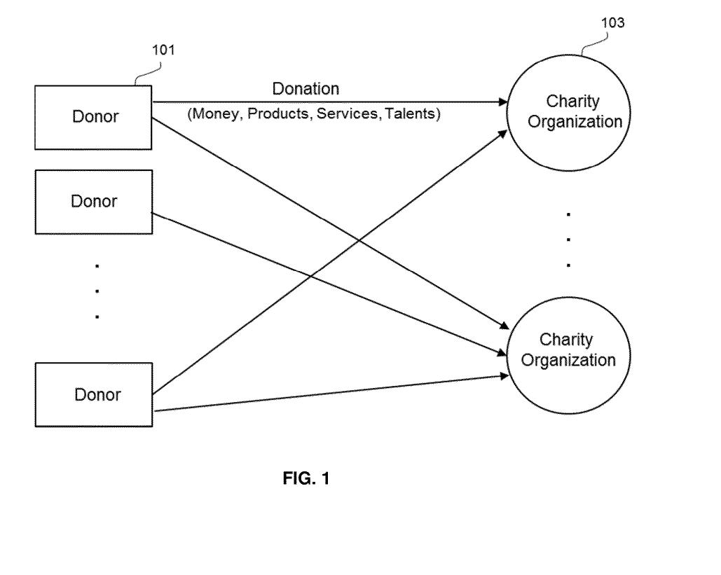

FIG. 1 illustrates a donor's donation type as a conventional donation method. As shown in FIG. 1, in the past, a donor (101) directly makes a donation to a charity organization (103) without an intermediate means between the donor and the charity organization such as 1:1, 1:N, N:1, and N:M donation methods in general, where N is not equal to M.

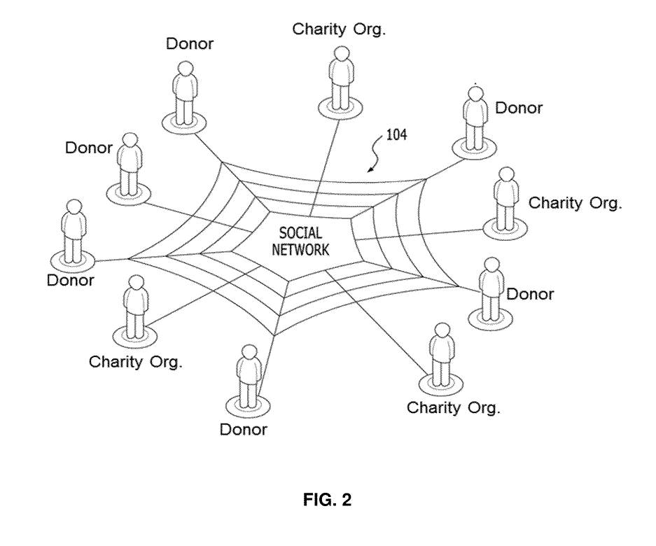

FIG. 2 depicts a donation method of a donor (101) and a charity organization (103) using a social network (104), in accordance with an example of an embodiment.

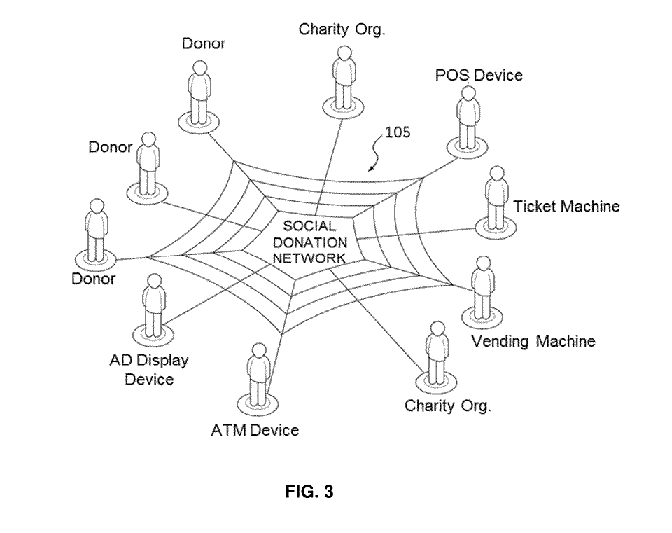

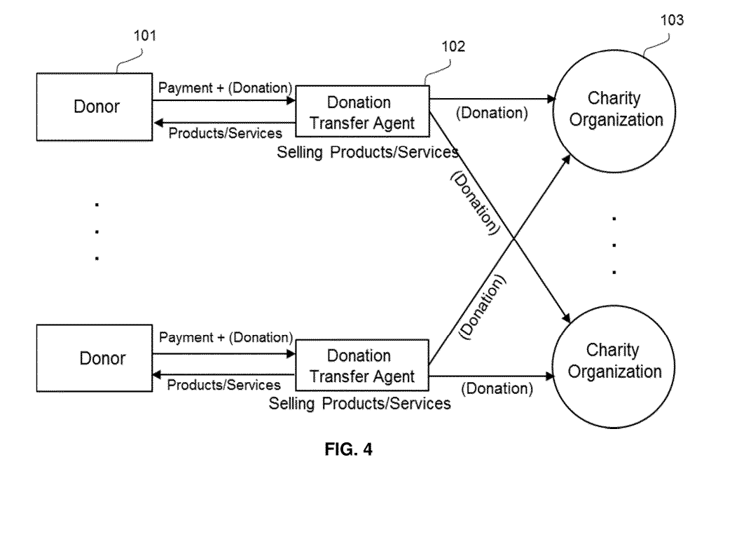

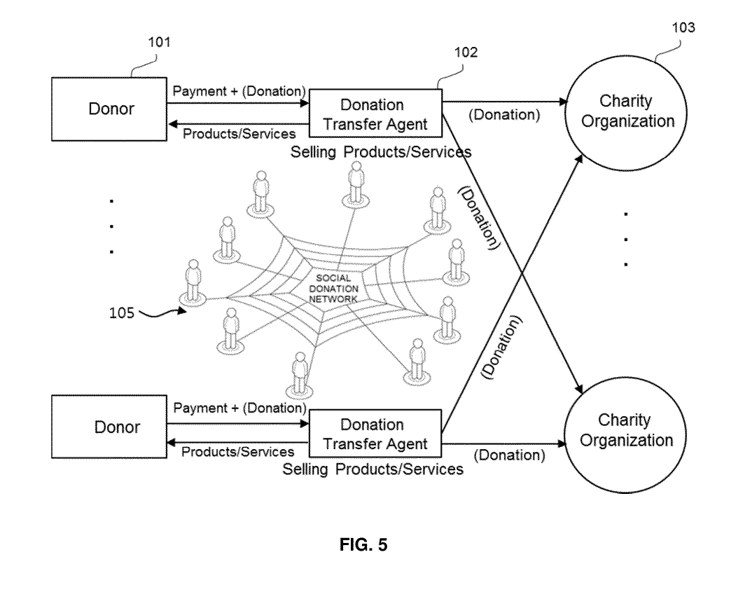

FIGS. 3, 4, and 5 show a social donation network as an extended social network, thereby adding a donation transfer agent (102) working within the devices such as a sales-assisting device, an advertisement display device, a PC, and a smartphone to the social network, according to an example of an embodiment of the present invention. The donation method using the social donation network (105) consists of the donor (101) and the charity organization (103) through the intermediate of the donation transfer agent (102).

In accordance with an example of an embodiment of a donation method, a donation transfer agent (102) comprises of a module, a service unit, a terminal device and the like as well as a person who helps the donor (101) to spend an amount of money or make a donation, in which money spending, consumption, money variations and more (hereinafter, referred to as ‘spending’ in an abbreviated form) are needed. Here, the module does not only encompass unmanned devices such as sales-assisting devices like a POS terminal, a slot machine (vending machine), and others, but it also contains designated modules capable of entering an amount of money such as mobile phones, tablets, computers, electronic devices, mobile terminal devices, server, network services, applications (App), and others.

According to an example of an embodiment of a donation method, a donation transfer agent (102) asks donation intentions to a donor (101) when the donor (101) wants to spend a certain amount of money, and after the donor (101) expresses a donation intention to the donation transfer agent (102), then the donation transfer agent (102) provides the purchased products, services and others to the donor (102) due to the donor (101)'s amount of expenditures. And the donation transfer agent (102) also transfers the donor (101)'s donation amount to the designated charity organization (103) and sends the donor (101)'s purchase amount to the seller at the same time, once the donor (101)'s donation decision is determined.

In accordance of an example of an embodiment of a donation method, when a charity organization (103) as a buyer, needs products or services, then the charity organization as a donor can make a donation to another charity organization without loss of generality because the donor and the charity organization belong within the same members in a social donation network (105).

In accordance with an example of an embodiment, a method for transferring donations from a donation transfer agent (102) to a charity organization (103) is carried out by a network transfer by wireless and wired network in the form of cash, vouchers, online money, goods, services, stocks, bonds, title certificates, and others as well as a direct transfer in cash.

According to an example of an embodiment of a donation method, a social network (104) can be modeled as a network containing a plurality of donors (101) and a plurality of charity organizations (103). The social network (104) can be extended to a social donation network (105), thereby adding a plurality of donation transfer agents (102) such as sales-assisting devices and other various devices such as PCs and smartphones connected to a social network (104).

According to an example of an embodiment, a social donation network (105) is a network that includes a donor (101), a donation transfer agent (102), and a charity organization (103), wherein friends and acquaintances (school connections, regional relations, kin, community (online/offline community, military, club meetings, etc.)) in the network are interlinked. This is an infinitely expandable network that is established through a mutual relation such as a friend, a friend of a friend, a friend of a friend of a friend, and more, and even an acquaintance, a friend of an acquaintance, a friend of a friend of an acquaintance, and more. In addition, the social donation network (105) contains the donors (101), the donation transfer agents (102), and the charity organizations (103), where the donation transfer agent (102) consists of the unmanned devices such as the POS terminals, ATMs, slot machines (vending machine), and others more, as well as mobile phones, tablets, computers, electronic devices, mobile terminal devices, servers, network services, applications (App), indoor and outdoor advertisement display devices, and more, which are also connected to form the social donation network.

In accordance with an example of an embodiment, the donation transfer agent (102) can be embedded in the donor (101)'s devices, charity organization (103)'s devices, indoor and outdoor advertisement display devices, POS devices, ATMs, vending machines, ticket machines, phones, computers, and others.

In accordance with an example of an embodiment, servers, network services, applications (App), indoor and outdoor advertisement display devices, and more include a means to point to an address of a particularly designated charity organization (103) in order to make a social donation.

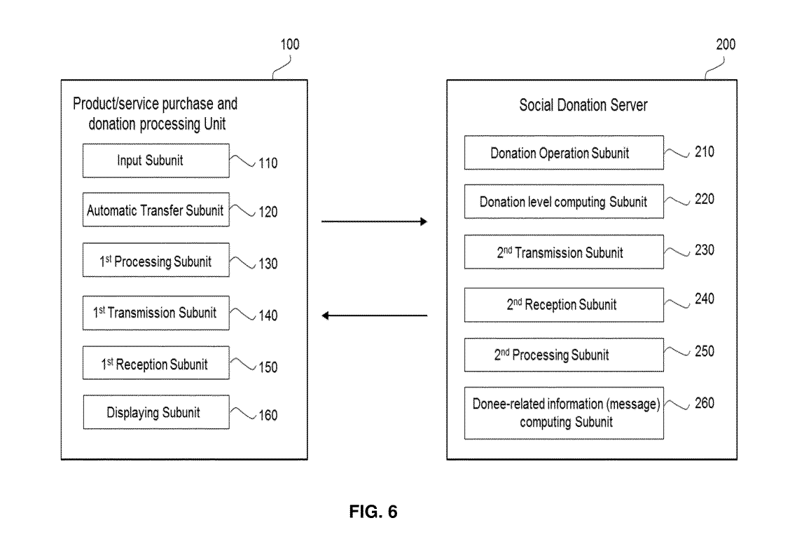

FIG. 6 illustrates a product/service purchase and donation processing unit (100) and a social donation server (200) as applicable, when an act of donation occurs, as an example of an embodiment of a system for collecting donations. Based on the integration and the connections of the aforementioned donor (101), donation transfer agent (102), charity organization (103), and social donation network (105), the donation transfer agent (102) can be included at the product/service purchase and donation processing unit (100), and the foregoing functions of the social donation network (105) are contained by what is operated on the social donation server (200). In other words, the social donation server (200) contains the following functionality such as, the constructions of social relationships and networking between a plurality of donors and the product/service purchase and donation processing unit (100) as well as the functions of the social donation network (105). It also stores the donor (101)'s information relevant to the donation, such as a donor (101)'s charity organization, the amount of donations that were made, age, religion, address, product or service preferences, favored policies, and others.

According to an example of an embodiment of the present invention, by applying context-awareness based technology, a product/service purchase and donation processing unit (100) for inducing decisions to make donations consists of an input subunit (110), an automatic transfer subunit (120), a first processing subunit (130), a first transmission subunit (140), a first reception subunit (150), and a displaying subunit (160).

In accordance with an example of an embodiment, when purchase of products or services, expenditures, consumption, money variations, and the like (hereinafter, referred to as “purchase” in abbreviation) are occurring, that is, providing intangible commodities such as beauty treatments, health fitness club, and etc., as well as purchasing all of the tangible products by buyers (donors), a product/service purchase and donation processing unit (100) contains not only an unmanned device such as a point of sale (POS) device, a slot machine (vending machines) stand, ticket machines, automatic coffee machines, automatic beverage and juice vending machines, and more, in the form of a kiosk, whereby it is possible to pay by credit card or cash and to give network connectivity functions. In addition, it also contains a designated module capable of entering an amount of money through a device's input parts such as payment terminals, mobile phones, tablets, computers, electronic devices, mobile terminal devices, indoor-and-outdoor advertisement display devices (digital signage), servers, network services, applications (App), and others.

In accordance with an example of an embodiment, an input subunit (110) has not only a separate keypad capable of entering both of the donor's amount of donation and the payment amount of products or services that will be purchased, but also a donor's touch screen or an additional input part permitting to enter both of the payment amount as well as the amount of donation by using wired and wireless communications.

In accordance with an example of an embodiment, an automatic transfer subunit (120) performs an automatic transfer of the donations into the accounts of the charity organizations by using an online payment system. The online payment can be carried out by integrating external financing servers (payment checkout servers) such as bank servers, wireless mobile carriers' servers, credit card companies' servers and others. In addition, the payment checkout server performs payment and settlement using wired or wireless communications such as WLAN (Wireless Local Area Network), WiMax (Worldwide Interoperability for Microwave Access), LTE (Long Term Evolution), and others.

In accordance with an example of an embodiment, a charity organization (103) as a group enforced to use collected donations is a non-profit one, including religious groups, welfare organizations, social organizations, political parties, local children care groups, schools, and others more. Moreover, the characteristics of the organizations are sufficient as long as there is a set of many people who need donations. Moreover, when it comes to the existence of the organization, it does not make a difference even if it does not have a name, or a form of association.

In accordance with an example of an embodiment, the account of a charity organization (103) is required to use electronic financial services such as money transfers, Internet banking, phone banking, mobile phone banking, and others. In addition, a virtual account service using a virtual account can also be included as another form of electronic financing service to make payments. A company with a large number of clients has a plurality of deposit identification numbers assigned to its clients, in order to deposit and withdraw money easily. Once the company obtains the virtual accounts from financial institutions, such as banks, it can distribute the virtual accounts to its own clients, and the clients can then use the distributed accounts, in order to deposit and pay their transactional money.

According to an example of an embodiment of the present invention, a first transmission subunit (140) directly transmits information relevant to donation such as the payment amount of products or services that have been purchased and the amount of donation which are entered or processed at a product/service purchase donation and processing unit (100), to a social donation server (200). The transmission uses general communication means that do not belong to specific wired or wireless communications such as LTE and more.

In accordance with an example of an embodiment of the present invention, a first reception subunit (150) receives donee related information (message) from a social donation server (200). The reception uses general communication means that do not belong to the specific communication ones.

In accordance with an example of an embodiment of the present invention, a displaying subunit (160) displays the received information (message) related to the donee onto a donor's display screen, and the used display device includes LCD (Liquid Crystal Display), and LED (Light Emitting Diode) screens, which are not constrained to a specific display device.

In accordance with an example of an embodiment of the present invention, a first processing subunit (130) contains a processing part with common knowledge and common use to process an input, a transmission, a reception, a storing, and connections of each subunit at the product/service purchase and donation processing unit (100).

In accordance with an example of an embodiment of the present invention, by applying a context-awareness technology, a social donation server (200) for inducing decisions to make donations consists of a donation operation subunit (210), a donation level computing subunit (220), a second transmission subunit (230), a second reception subunit (240), a second processing subunit (250), and a donee related information (message) computing subunit (260).

In accordance with an example of an embodiment of the present invention, a donation operation subunit (210) manages and operates collected donations in relation to the purchased products or services by being complied into a database. Furthermore, it also manages and operates donation details such as the amounts of donation by donors (101), charity organizations (103), time of donation, the places of the purchased products or services, donation frequencies and more, and the preferred charity organizations (103) of the donors (101) and more at the moment of purchase of these products or services.

In accordance with an example of an embodiment of the present invention, a donation level computing subunit (220) computes a level of donation corresponding to a donor (101)'s donation preference level or donation amount level or even both levels.

In accordance with an example of an embodiment of the present invention, to do an act with a specific determination (for example, voting for a particular candidate, an act of donation for a specific charity organization (103), or an act of purchasing a particular product or a service), prior to executing the act, it is required for a person to make a decision. Thus, computing a donation level is referenced to mathematically quantify or model for an act of donation. With a sales-assisting device attached to (or included with) a system for inducing decisions to make donations, prior to the payment, a donor (101) (a buyer) who wants to purchase products or services could make a donation or not, just by viewing the advertisement or the promotional messages that are shown on the device whereby the message for the buyer has been carefully prepared to be favorable based on the buyer's personal preference. The results that are to be accomplished by the system to induce decisions to make donations are either 1 or 0. If the corresponding buyer was induced to make a donation and then decided to make the donation, then the result is 1, and on the contrary, if the buyer did not make the donation, then the result is 0. There exists only two cases, and depending on the result of the action, the donation preference level and the donation amount level are computed again for the corresponding buyer.

In other words, we can assume that each individual has an existence of accumulated preferences (or propensity), and a person's preference can be segmented by 0.0˜1.0, 0.0˜10.0, 0.0˜100.0, and more or less levels in various ways, but simply we suppose that the preference is a set of real numbers ranging from 0.0˜1.0. In the case of a real number set with values between 0.0˜1.0, 1.0 means it is favorable, and 0.0 is unfavorable. Otherwise, the opposite case can also be considered. An initial preference of all the people is 0.5 as an assumption, meaning that all of the people initially start from a neutral preference.

Through the sales-assisting device, each time a person purchases products or services and makes a decision to donate to a specific charity organization, by reflecting the accumulated individual preferences, it means that depending on the results of the decisions, a donation preference level and a donation amount level are required to update the results of the action (that is, if there was a donation or if there was not).

First of all, in the case of making a donation, a donation preference level of the corresponding buyer increases. On the other hand, when a donation has not been made, the donation preference level of the buyer decreases. In addition, the donation preference level is updated to reflect an action as a result of donation per purchase. The donation preference level is embodied according to the simple mathematical expression below. In order to forecast a future act of donation, by simply reflecting the past donation history and the result of the current act of donation, in accordance with an example of an embodiment, a mathematical formula called EWMA (Exponentially Weighted Moving Average) is chosen as an alternative instance even if other similar formulae relating to the forecasting can also be chosen.

AFₙₑₓₜ=AFₚᵣₑᵥ+α(AF_{curr}−AFₚᵣₑᵥ)
α: Smoothing factor (0<α<1)

In the mathematical expression above, AFprev means AFnext which was previously calculated upon an act of purchase, AFcurr is substituted with a value resulting from the current act of purchase (in the case where donation has been made: 1, in the case where donation has not been made: 0). AFnext representing as a real value with a scope of [0.0, 1.0] is used to expect a donation preference level for the next donation by reflecting the present act of donation and the past donation history to the corresponding buyer, immediately after an act of purchase. A person who has been making a lot of donations has a value of more than 0.5, and a person who always makes a donation when purchasing products or service has a value near to 1.0. On the other hand, a person who never makes a donation has a donation preference level that is close to 0. Depending on the applications, α defined as a smoothing constant (or factor) has a value in the range of 0<α<1. By placing an emphasis on the recent date (α has a large value) or by imposing an emphasis on the past data, which includes the current data (α is set to a small value), it is possible to freely adjust. For example, when a person with the initial value of 0.5 makes a donation where a value is previously set to 0.1, in this case, according to the following expression AFnext=0.5+0.1*(1−0.5), the person has a value of 0.5+0.05=0.55 as a donation preference level.

The calculation of a donation amount level is necessary to maintain a moving average value for the amount of donation, set aside from the donation frequency per each donor (buyer). Therefore, the donation amount level is also computed like the same mathematical expression that is illustrated below.

DONATIONₙₑₓₜ−DONATIONₚᵣₑᵥ+α(DONATION_{curr}−DONATIONₚᵣₑᵥ)
α: smoothing factor (0<α<1)

Computing a donation amount level is similar to the case of the donation preference level, and DONATIONprev means DONATIONnext which is computed upon a previous act of purchase, and DONATIONcurr is substituted with a value of the result in regards to the current amount of donation. DONATIONnext is represented as the meaning of the level of the amount of donation reflected by the current act of donation and the past donation history. Depending on the application, α is known as a smoothing constant (or factor) and also has a value in the range of 0<α<1. By emphasizing the recent data (α's value is set to large) or in the case of emphasizing the past data including the latest data (α's value is set to small), it is possible to adjust a's value. For example, when a person with 5 US Dollars as an initial amount of donation decides to make another donation of 10 US Dollars, and a value of α is set to 0.1, in this case, according to the following expression, DONATIONnext=5+0.1*(10−5), the person will have 5+0.5=5.5 as a donation amount level.

In accordance with an example of an embodiment of the present invention, previously stored information (message) that is relevant to the donee is provided to the donor, counteractively with the foregoing donation preference level or donation amount level or even both levels.

To provide donee related information (message) to the donor, it is required to persuade donor(buyer)'s mind in order to induce donation from a donor (buyer). In this case, unlike a method that is applicable to the existing machine learning, for this purpose, a method is devised to prepare a preliminary advertisement or a message list, and to provide it to the donor when there is an act of purchase. The preparation of the message list provides not only the most perfectly matching information (message) to the donors (101) in real time, but it also contains the most suitable campaign information (message) for the buyer to support a certain political party or a candidate in an election. In addition, in the case of educational services, by reflecting what the students need and lack, it will be essential to provide information (message) related to education to the students depending on their preferences and responses, and it will also be possible to apply the demanded fields, in order to provide a more customized educational service.

Not limited to the aforementioned example of an embodiment, when customizing information for the whole society such as anything related to education, cultures, politics, economics and others are demanded, it contains the specific information on the domain for providing these services. In accordance with an example of an embodiment, in the case of an election, each presidential candidate pledges different promises to the public and the presidential election promises can be normally divided between the conservatives and the progressives, each divided by 0.0 to 1.0 levels as shown in FIG. 14, wherein the promises are listed in a set of messages categorized in an order, according to the appeal and the strength of the promises. As for the previously stored messages, they are prepared manually by experts in the domain or automatically by machine learning.

However, the illustrated example above is not always fixed to a constant type, but it contains changes and updates on methods to extract messages concerning a charity organization, experts working in donation related fields, types of donations and others.

In accordance with an example of an embodiment of the present invention, information (message) relevant to the donee is constructed from the basis of previously stored information constituting the donor (101)'s profile (work, education, hobby, political views, date of birth, address, religion, etc.). When a donor (101) purchases products or services, based on an identification number of the corresponding donor (101), it searches a buyer (donor)'s profile, and then chooses a message list that is randomly extracted from one of the different categories such as education, religion, hometown, politics, and others, while each category has its own message list. Furthermore, it chooses the donee related information (message), which is closely matching to the corresponding donation preference level or donation amount level amongst the messages that are stored within the chosen message list. If any matched information cannot be found, then it randomly chooses donee related information (message) at an initial (or neutral) level from one of the message lists, thereby attempting to trigger a donation inducement under any circumstances, no matter what it matches.

In accordance with an example of an embodiment, when a donor has a preference on a specific message for inducing donation, then the donor can make a donation to various charity organizations, which therefore, provides a list of various charity organizations that is relevant to the message.

In accordance with an example of an embodiment of the present invention, even if the donor (101)'s preferential information exists, but does not match accordingly, then it triggers the provision of the donee related information (message) which is randomly chosen from a message set of donation inducement, given to a donor in order to induce donation. Moreover, when the donor (101)'s preferential information does not exist, then it provides the message that is matched at the initial (or neutral) level, by randomly choosing from one of the message lists and given to the donor in order to induce donation, thereby enabling to provide an adaptive and repetitive donation inducement, rather than a static and one-time inducement kind.

In accordance with an example of an embodiment of the present invention, when a misfortune such as a natural disaster has occurred, a specific and special event to collect and raise donations can be included. In this case, donee related information (message), which is not matched to the previously stored messages, contains a method to induce donations when a purchase has occurred, by searching through the messages that are stored, according to the events that match the donor's (101)'s donation preference level or donation amount one. It can provide a donation based on an event even if the donor is matched or unmatched with the charity organization.

In accordance with an example of an embodiment of this invention, by using the previously described choice and the method to extract event messages, it is possible to search for a message or to provide it. For example, in the case of an election, if it is stored as “progressive” in a donor (101)'s profile, then it will extract the messages that were prepared by a progressive party, and it will also include the feature of presenting the messages to induce the donor (101) into making donations.

In accordance with an example of an embodiment of the present invention, by receiving ‘donee related information containing a message for donation inducement’, a donor (101) may try to make a donation or not, and a social donation server (or a donation management unit in the case of an offline payment) can reversely estimate the donor's preference depending on the donation results. For example, if a donor does not enter an item in the category of a political view, in order to protect his/her personal privacy, a social donation server (200) does not know about his/her personal political preferences at that time. When the donor positively responds to make a donation to a certain political party, then the social donation server accumulates relevant donation results and can predict on the donor's preferences by reversely estimating that he/she has a favor towards the political party.

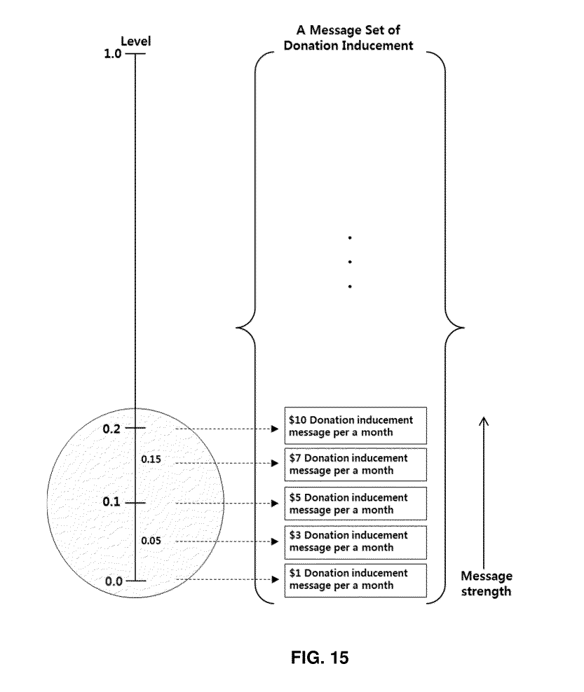

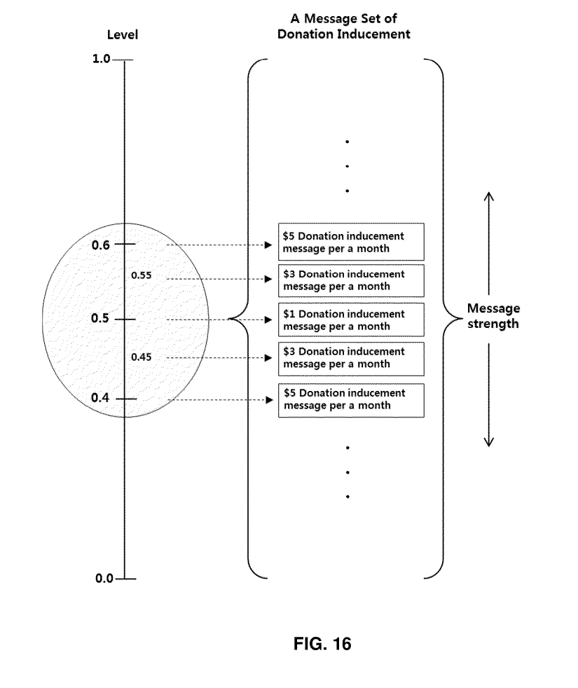

By extracting previously stored messages that correspond to a donation preference level or donation amount one or both levels, a method to provide an appropriate message to a donor to induce donations is illustrated in FIGS. 15 and 16, in which two instances show a message set of donation inducement starting from the lower level and the other from the mid-level. A message list can be constructed from each preferential category, and each message list contains a message set of donation inducement listed in an order according to the appeal and the strength of the message. The stored message list is classified into either a unilateral message list or a bilateral one depending on the applicable domains. The unilateral message list contains only one issue. For example, in the occurrence of a hurricane, the message with the lowest appeal and strength when it comes to inducing donation is located in the lowest position, and vice versa. When there is no matching to the donor's preference, then the lowest level is chosen and the corresponding message according to the matching level is fetched and given to a donor. On the other hand, a bilateral message list has two extremities. For example, two opposing opinions such as the conservative versus the liberal political parties. The bilateral message list contains only two disparate issues and the message with the lowest appeal and strength when it comes to inducing donation is located in the middle. When there is no match, then the mid-level (or neutral level) can be chosen as a start and the corresponding message in accordance to the matching level is also fetched and given to a donor.

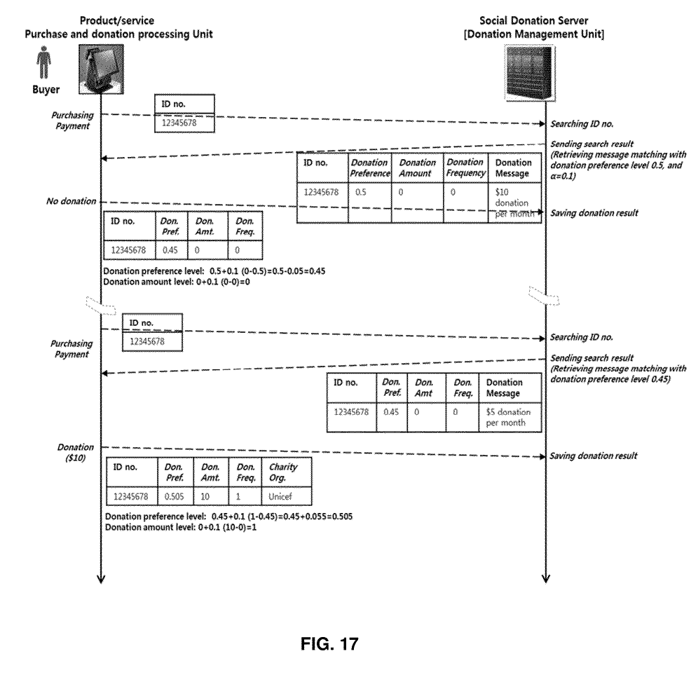

According to an example of an embodiment of the present invention, we shall take an example as shown in FIG. 17, which illustrates a timing diagram with donation flows between a product/service purchase and donation processing unit (100) and a social donation server (200). When it is working in an offline payment system, a donation management unit is used on behalf of the social donation server, according to an example of an embodiment.

In other words, in accordance with an example of an embodiment of the present invention, when a donor (101), as a buyer purchases products or services, by determining whether the donor makes a donation or not, it depends on the transferred information related to the donee (including a message of donation inducement), the amount of purchase and the amount of donation using an input subunit (110), which are all entered at a product/service purchase and donation processing unit (100). Then after, the corresponding amount of the purchase and the donation, and any information relevant to a donor are transmitted to a social donation server (200) by a first transmission subunit (140), and by using the basis of information received from a second reception subunit (240), then a level of donation of the donor (101) is computed and updated at a donation level computing subunit (220). In accordance with the updated levels of donation indicated above when it comes to the next purchase, via a donee-related information (message) computing subunit (260), a message that is suitable to the donor (101) is extracted. The extracted message is transmitted to the product/service purchase and donation processing unit (100) by a second transmission subunit (230). Based on this message, the donor (101) donates a certain amount to a charity organization. First of all, if a donation is not made, assuming that a donation preference level is set to 0.5 as an initial value and a=0.1, the donation preference level is updated as 0.5+0.1*(0−0.5)=0.45, and an initial donation amount level is set to 0. Once again, following the next purchase, if 10 US Dollars is paid as a donation, then the current donation preference level is updated to 0.45+0.1*(1−0.45)=0.505, and the donation amount level is again renewed to 0+0.1*(10−0)=1. Both of the donation levels that are renewed by the donations are stored and managed at the social donation server (200).

In accordance with an example of an embodiment of the present invention, a second transmission subunit (230) transmits a donation preference level, a donation amount level, as well as the donee related information (message) that is suitable for a donor (101) will be entered and processed by a donee related information (message) computing subunit (260) to a product/service purchase and donation processing unit (100) by a social donation server (200). The transmission uses general communication means that are not limited to certain wired and wireless, or LTE, and others.

In accordance with an example of an embodiment of the present invention, a second reception subunit (240) receives information relevant to an amount of purchase, an amount of donation, and donee related information from a product/service purchase and donation processing unit (100). The reception uses general communication means, which is not limited to certain communication ones.

According to an example of an embodiment of the present invention, a second processing subunit (250) contains a processing part with common knowledge and common use, in order to process the input, transmission, reception, storing, and connections of each subunit at the social donation server (200).

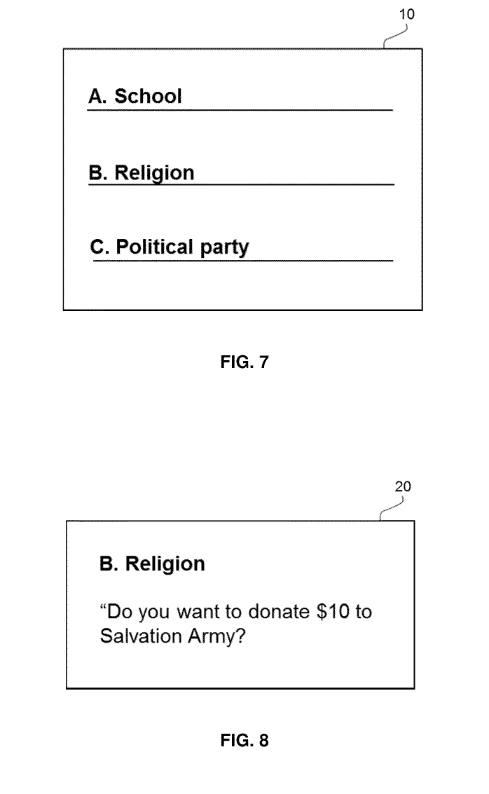

FIG. 7 shows an example of a donation that will be displayed to a donor, in accordance with an example of an embodiment.

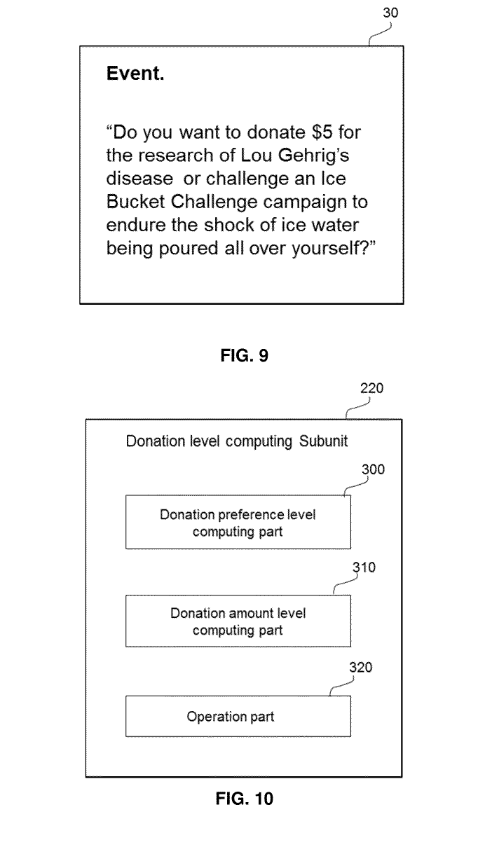

Not limited to an example of a specific embodiment, a donor can freely choose a charity organization among “A. school, B. religion, and C. political party” from a charity organization list, and when the donor (101) chooses “B. religion”, as an example of an embodiment for “B. religion” is displayed to the donor (101), as shown in FIG. 8. In addition, as an example of an embodiment, when a certain event, incident, or disaster, and others are occurred, the donation information related to the occurrences as well as the previously stored information related to donation are also displayed to the donor (101) as shown in FIG. 9.

FIG. 10 illustrates a donation level computing subunit (220), in accordance with an example of an embodiment of a system for collecting donations.

The donation level computing subunit (220) contains a donation preference level computing part (300), a donation amount level computing part (310) to compute the previously described donation levels, and an operation part (320).

A donation preference level computing part (300) and a donation amount level computing part (310) denote a designated module that is operated by the aforementioned computation of donation levels. Furthermore, an operation part (320) using a technology of common knowledge and of common use operates and manages a donation level computing subunit (220).

According to an example of an embodiment of the present invention, a product/service purchase and donation processing unit (100) integrating with a donation management unit, which has the same features as the aforementioned social donation server (200) except it is not connected to a network are built in an offline device, thereby operating with the same functionality in combination with two different features.

In accordance with an example of an embodiment, an offline device contains a cash register, a slot machine (vending machine), a ticket machine, and an unmanned automatic sales system.

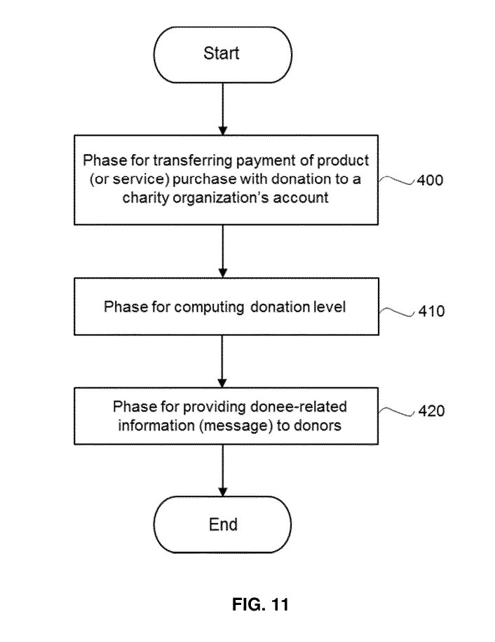

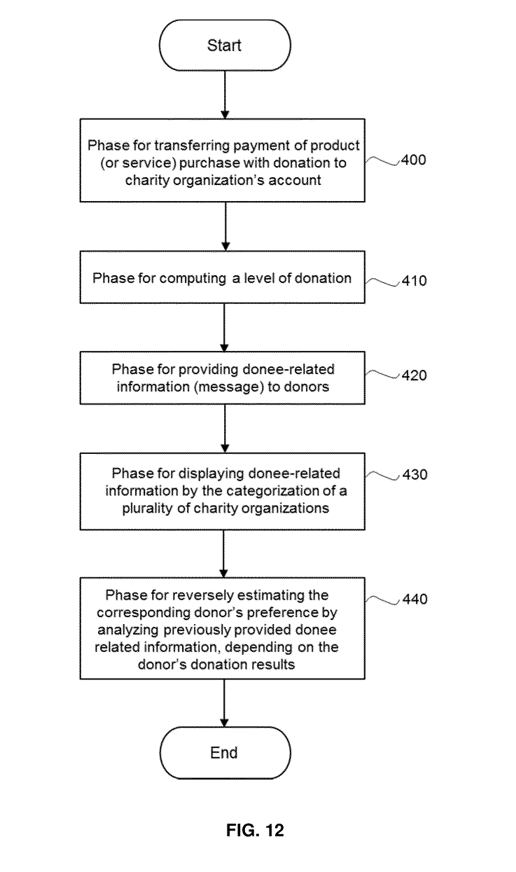

FIG. 11 illustrates a flowchart for a donation method, in accordance with an example of an embodiment, and FIG. 12 also depicts a flowchart for a donation method as another example of an embodiment. The process of the donation is similar to the aforementioned one. Therefore, the detailed explanations are omitted.

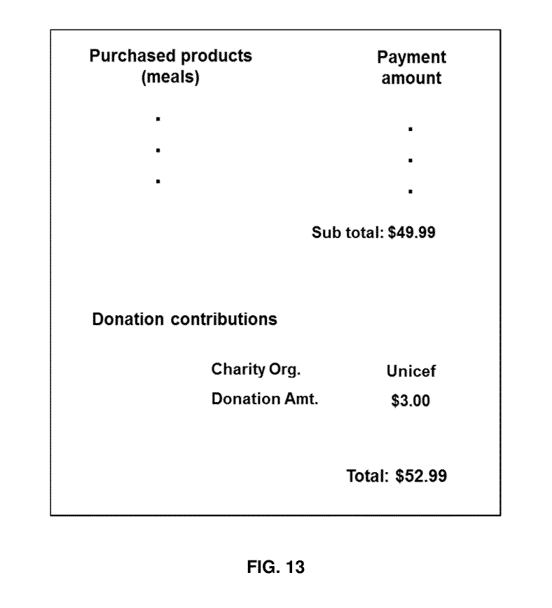

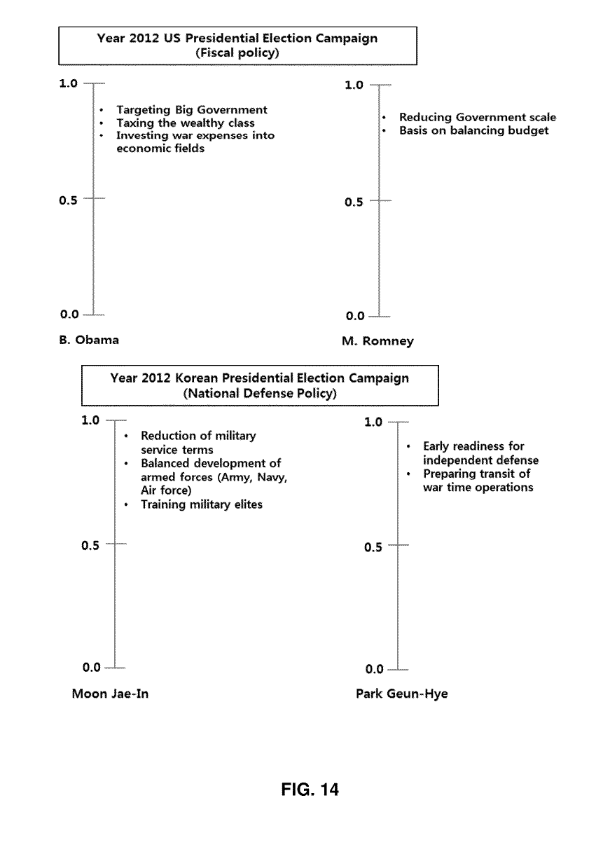

FIG. 13 shows a donation receipt (380), in accordance with an example of an embodiment.

As an example of an embodiment of the present invention, by showing a charity organization (103) and an amount of donation, a receipt (380) allows a donor (101) to clearly be aware of the charity organization (103), the donation patterns, and the information. Moreover, by exploiting an amount of donation in the receipt (380), the donor (101) can facilitate to report the amount of donation to an IRS (Internal Revenue Service) for tax reimbursements.

### EXPLANATIONS OF SYMBOLS

100: Product/service purchase and donation processing unit
101: Donor
102: Donation Transfer Agent
110: Input subunit
103: Charity organization
120: Automatic transfer subunit
104: Social network
105 Social donation network
130: First processing subunit
140: First transmission subunit
150: First reception subunit
160: Displaying subunit
200: Social donation server
210: Donation operation subunit
220: Donation level computing subunit
230: Second transmission subunit
240: Second reception subunit
250: Second processing subunit
260: Donee-related information (message) computing subunit
300: Donation preference level computing part
310: Donation amount level computing part
320: Operation part
380: Receipt

What is claimed is:

1. A system for collecting donations when purchasing products or services by using an online payment system, comprising:
a product/service purchase and donation processing unit, wherein, it transfers an amount of donation, which is to be entered by determining on the ‘donee related information containing a message for donation inducement’ received from a social donation server to an account of a charity organization;
and the social donation server, wherein, it manages and operates the transferred donations, and it computes a level of donation corresponding to a donation preference level or a donation amount level or even both levels by predicting a future act of donation in reflection of a past donation history (donation preference and donation amount levels) and a current act of donation (donation results and donation amount), and it provides as a result, ‘donee related information containing a message for donation inducement’ which is closely matched with the level of donation to the donor by the product/service purchase and donation processing unit, the next time the donor purchases products or services.

2. The system of claim 1, wherein the charity organization consists of a plurality of charity organizations, and the charity organization's account is chosen by the donor amongst the plurality of charity organizations.

3. The system of claim 2, wherein the product/service purchase and donation processing unit receives ‘donee related information containing a message for donation inducement’ which is closely matched to the computed level of donation from the social donation server, and wherein it consists of a displaying subunit, which categorizes the received donee related information into the plurality of charity organizations and then displays it.

4. The system of claim 3, wherein the displaying subunit displays detailed information concerning the chosen charity organization once the donor chooses one of the categorized plurality of charity organizations.

5. The system of claim 1, wherein the social donation server provides ‘donee related information containing a message for donation inducement’ that matches with the donor's level of donation as well as the additionally entered numerical values of the donation information by the product/service purchase and donation processing unit to the donor, not the previously stored donee related information.

6. The system of claim 1, wherein the social donation server computes and then updates the donor's level of donation based on the donor's past donation amount and current donation amount, as well as the donor's donation preference level based on the donor's past donation history and current donation intentions, and it also computes by using the donation preference level or the donation amount level or even both levels.

7. The system of claim 1, wherein the product/service purchase and donation processing unit is attached to a manned or an unmanned automatic sales system.

8. The system of claim 6, wherein the product/service purchase and donation processing unit is attached to a manned or an unmanned automatic sales system.

9. The system of claim 1, wherein the social donation server is constructing a social relationship network between the plurality of donors and the product/service purchase and donation processing unit, based on one or more donor's information chosen from the donors' information regarding the donation, including the donor's selected charity organization information, as well as the information on the amount of donation, age, religion, address, product preference, and policy preferences, and others.

10. The system of claim 1, wherein the social donation server reversely estimates the corresponding donor's preference by analyzing previously provided donee related information, depending on the results of the donor's donation.

11. A system for collecting donations when purchasing products or services by using an offline payment system, comprising:
a product/service purchase and donation processing unit, wherein, it transfers an amount of donation, which is to be entered by determining on the ‘donee related information containing a message for donation inducement’ received from a donation management unit to an account of a charity organization;
and the donation management unit, wherein it manages and operates the provided donations, and it computes a level of donation that corresponds to a donation preference level or a donation amount level or even both levels by predicting a future act of donation in reflection of a past donation history (donation preference and donation amount levels) and the current act of donation (donation results and donation amount), and it provides as a result, ‘donee related information containing a message for donation inducement’ which is closely matched with the level of donation to the donor by the product/service purchase and donation unit, the next time the donor purchases products or services.

12. The system of claim 11, wherein the donation management unit computes and then updates the donor's level of donation based on the donor's past donation amounts and current donation amount, as well as the donor's donation preference level based on the donor's past donation history and current donation intentions, and it also computes by using the donation preference level or the donation amount level or even both levels.

13. The system of claim 11, wherein the product purchase and donation processing unit and the donation management unit are attached to an unmanned automatic sales system.

14. The system of claim 11, wherein the donation management unit reversely estimates the corresponding donor's preference by analyzing previously provided donee related information, depending on the donor's donation results.

15. A method for collecting donations when purchasing products or services by using an online payment system, comprising:
a transferring phase, wherein it transfers an amount of donation, which is to be entered by determining on the ‘donee related information containing a message for donation inducement’ that is received to an account of a charity organization, when a donor purchases products or services; and
a computing donation level phase, wherein it computes a donation level corresponding to a donation preference level or a donation amount level or even both levels by predicting a future act of donation in reflection of a past donation history (donation preference and donation amount levels) and current act of donation (donation results and donation amount); and
a providing phase, wherein it provides as a result, ‘donee related information containing a message for donation inducement’ which is closely matched with the level of donation to the donor, the next time the donor purchases products or services.

16. The method of claim 15, wherein the charity organization consists of a plurality of charity organizations, and the charity organization's account is chosen by the donor amongst the plurality of charity organizations.

17. The method of claim 16, wherein it receives ‘donee related information containing a message for donation inducement’ which is closely matched to the computed level of donation, and includes a displaying phase, which displays the received donee related information by categorizing according to the plurality of charity organizations.

18. The method of claim 17, wherein the displaying phase displays detailed information concerning the chosen charity organization once the donor chooses one of the categorized plurality of charity organizations.

19. The method of claim 15, wherein the computing donation level phase provides ‘donee related information containing a message for donation inducement’ which is closely matched with the donor's level of donation as well as with the additionally entered numerical values of the donation information to the donor, not the previously stored donee related information.

20. The method of claim 15, wherein the computing donation level phase also computes and then updates the donor's donation amount level based on the donor's past donation amount, and the current donation amount, as well as the donor's donation preference level based on the donor's past donation history and current donation intentions, and it also computes by using the donation preference level or the donation amount level or even both levels.

21. The method of claim 15, wherein it includes an estimating phase, which reversely estimates the corresponding donor's preference by analyzing previously provided donee related information, depending on the donor's donation results.

22. A method for collecting donations when purchasing products or services by using an offline payment system, comprising:
a transferring phase, wherein it transfers an amount of donation, which is to be entered by determining on the ‘donee related information containing a message for donation inducement’ that is received to an account of a charity organization, when a donor purchases products or services;
a computing donation level phase, wherein it computes a level of donation corresponding to a donation preference level or a donation amount level or even both levels by predicting a future act of donation in reflection of the past donation history (donation preference and donation amount levels) and current act of donation (donation results and donation amount); and
a providing phase, wherein it provides as a result, ‘donee related information containing a message for donation inducement’ which is closely matched with the level of donation to the donor, the next time the donor purchases products or services.

23. The method of claim 22, wherein the computing donation level phase also computes and then updates the donor's donation amount level based on the donor's past donation amount and current donation amount, as well as the donor's donation preference level based on the donor's past donation history and current donation intentions, and it also computes by using the donation preference level or the donation amount level or even both levels.

24. The method of claim 22, wherein it includes an estimating phase, which reversely estimates the corresponding donor's preference by analyzing previously provided donee related information, depending on the donor's donation results.
